(19) United States
(12) Patent Application Publication
(10) Pub. No.: US 2010/0047760 A1
(43) Pub. Date: Feb. 25, 2010

(54) METHOD AND SYSTEM FOR DELIVERING PERFORMANCE BASED EMULATION TESTING

(76) Inventors: Mike Best, Woodstock, GA (US); Farai Chizana, Cape Town (ZA); Chizana Tapiwa, Bulawayo (ZA); Anton DeGruchy, Canton, GA (US); Jonathan Househam, Cape Town (ZA); Arno Louwrens, Durbanville (ZA); Jim McDonnell, Alpharetta, GA (US); Gert Smit, Cape Town (ZA); Charl Young, Brackenfel (ZA)

Correspondence Address: KENYON & KENYON LLP, ONE BROADWAY, NEW YORK, NY, 10004, US

(21) Appl. No.: 12/544,287

(22) Filed: Aug. 20, 2009

Related U.S. Application Data
(60) Provisional application No. 61/090,413, filed on Aug. 20, 2008.

(51) Int. Cl. G09B 7/00; G06F 3/048

(52) U.S. Cl. 434/362; 715/777

(57) ABSTRACT

A computer system and method may include a processor instantiating a test scenario that includes a description of a stem that defines a context and at least one task to be performed in accordance with the context and via interaction with at least one target application; providing an interface to an instance of the at least one target application for the interaction; executing one or more stored evaluation queries to check a status of the instance of the at least one target application and record one or more binary values based on the status; and executing one or more stored scoring expressions to generate and output a score, the scoring expression defining a function having input parameters that are based on the one or more binary values. The processor may further provide an authoring environment in which to define the test scenario, evaluation queries, and scoring expressions.

### CROSS-REFERENCE TO RELATED APPLICATION

This application claims priority to U.S. Provisional Patent Application No. 61/090,413, filed Aug. 20, 2008, the disclosure of which is herein incorporated by reference in its entirety.

### BACKGROUND

Performance based emulation testing is a testing technique which provides a mechanism for a test taker to interact with live computer systems. The test taker is placed into an environment where test scenarios are presented and the test taker uses the test taker's knowledge and skills to perform the tasks outlined in the scenarios. Performance is measured by grading the tasks actually performed by the test taker on the system which correlate to tasks performed on the job in a realistic setting.

Performance based testing is used in many professions to test competency. Airline pilots and firemen are often tested using performance based testing to test for responses under likely scenarios encountered on the job. The likely result of underperformance is being sent back for remedial training and practice. In Information Technology, where a level of competence in a particular skill domain is expected on the job, performance based testing is gaining increasing credibility in skills measurement because it is “testing by doing.”

Performance based testing is being applied to computer software where the test scenarios emulate the behavior of a particular or set of applications hosted on virtual machines and the test taker is asked to perform the specified tasks within the scenario. As with any test, performance based tests are administered in a controlled, proctored, and secure setting. Notes or reference materials are not usually allowed and the test is timed. Instead of recalling facts and trying to choose the right answer to multiple choice questions, the test taker uses the actual technology to attempt the tasks in the scenario. Test scenarios resemble actual job tasks or job samples and involve the execution of these tasks. When the test taker ends the scenario, all tasks are graded and scored and subsequently rolled up to an overall score for the test.

Current performance based testing requires a lot of work to be done by system administrators to configure the environment of multiple computers and network connectivity as well as the scenario and tasks to be presented. The grading of these tasks is also more difficult than the typical multiple choice question where answers are distinctly right or wrong. With performance based tasks, there are often multiple paths and approaches to performing the task, which may each result in a correct response. There is a need for better methods for authoring and grading scenarios as well as easing the burden of setup/teardown of environments currently done by system administrators.

### SUMMARY

The object of this invention is to provide a method and a system for enabling the authoring and delivery of automated grading of performance-based scenarios running on virtual machines. In an example embodiment of the present invention, the invention provides a method for defining an emulation based testing scenario object and all of the scenario elements to take the scenario into a delivery system which understands that scenario object. A preferred example embodiment of this invention provides for defining the scenario object being developed in an Editor application which understands the scenario elements and enables the scenario author to compose the scenario elements easily without requiring an understanding of the underlying technology required to deploy the scenario to the test taking environment.

In an example embodiment of the present invention, the invention provides a system for presenting the emulation based testing scenario to the test taker and method for using the scenario elements to perform automated grading and scoring of all attempted tasks. According to a preferred example embodiment of the invention, virtual server technology may be used to present a group of computer systems on which the test taker performs the scenario tasks. When the test taker indicates all attempts at performing the tasks have been completed, the scenario elements may be used on the virtual servers to perform automated grading and scoring before posting the results back to a test results management system.

An example embodiment of the present invention is directed to a method for facilitating generation of a test may include: providing by a computer processor a computer-implemented authoring environment that facilitates: drafting a test scenario including a description of a stem that defines a context and at least one task to be performed in accordance with the context and via interaction with at least one target application; defining a plurality of evaluation queries, which, when executed, cause a processor to check a status of the at least one target application, where, for each of the evaluation queries, a result of a respective status check is recorded as a respective binary result; and defining a plurality of scoring expressions, each expression associated with a respective one or more of the evaluation queries and defining a respective point scheme to be executed based on the recorded binary results of the respective one or more evaluation queries.

In an example embodiment of the present invention, the authoring environment includes a plurality of displayed tabs selectable for access to a respective display area, one of the tabs corresponding to an interactive display area in which a stem is definable in response to user input for interaction with the interactive display area; and a stem defined in the interactive display area is stored for subsequent retrieval of at least a portion of which as test instructions.

In an example embodiment of the present invention, which may be combinable with the previously described embodiment or implemented without the previously described embodiment, the authoring environment includes a plurality of displayed tabs selectable for access to a respective display area, one of the tabs corresponding to an interactive display area in which a stem is definable in response to user input for interaction with the interactive display area; and a stem defined in the interactive display area is stored for subsequent application to which of one or more of the plurality of evaluation queries.

In an example embodiment of the present invention, which may be combinable with one or more of the previously described embodiments or implemented without the previously described embodiments, the method further includes storing in a memory device the test scenario, evaluation queries, and scoring expressions.

According to an implementation of this embodiment, the storing of the test scenario, evaluation queries, and scoring expressions is performed: by the authoring environment in response to respective user input indicating the completion of the respective ones of the test scenario, evaluation queries, and scoring expressions; and in such a manner that the test scenario, evaluation queries, and scoring expressions are accessible for administering a test and for processing to score the test.

According to another implementation of the embodiment, which may be combinable with the previously described implementation or may be implemented without the previously described implementation, the authoring environment stores the at least one task and the plurality of evaluation queries as separate files and facilitates defining one or more checkpoints that associate the evaluation queries with one or more respective ones of the at least one task.

According to another implementation of the embodiment, which may be combinable with one or more of the previously described implementations or may be implemented without those previously described implementations, the authoring environment facilitates defining one or more checkpoints; each checkpoint is associable with a plurality of the evaluation queries; and a binary result for each checkpoint is computed based on the binary results of the evaluation queries that belong to the checkpoint and is referenced by the scoring expressions.

Another feature of this implementation may be that, for a checkpoint that is associated with more than one evaluation query, the checkpoint specifies an order in which its associated evaluation queries are to be executed.

An additional feature of this implementation may be that the authoring environment includes a user interface displaying an arrow arrangement selectable via an input device for modifying specification of an order of execution of evaluation queries associated with a checkpoint.

Another feature of this implementation, which may be combinable with one or more of the previously described features of the implementation or may be implemented without those previously described features, may be that a checkpoint specifies, for each of its associated evaluation queries, a virtual server on which the query is to be run.

Another feature of this implementation, which may be combinable with one or more of the previously described features of the implementation or may be implemented without those previously described features, may be that a scoring expression defines an algebraic function whose input parameters are the computed binary results of a plurality of the checkpoints.

According to another implementation of the embodiment, which may be combinable with one or more of the previously described implementations or may be implemented without those previously described implementations, the stored test scenarios are accessible for instantiation by a plurality of terminals and the evaluation queries and scoring expressions are accessible for instantiation to score the instantiated test scenarios.

An example embodiment of the present invention is directed to a computer-implemented testing method, including: instantiating, by one or more computer processors, a test scenario that includes a description of a stem that defines a context and at least one task to be performed in accordance with the context and via interaction with at least one target application; providing, by the one or more processors, an interface to an instance of the at least one target application for the interaction; executing, by the one or more processors, one or more stored evaluation queries to check a status of the instance of the at least one target application and record one or more binary values based on the status; and executing, by the one or more processors, one or more stored scoring expressions to generate and output a score, the scoring expression defining a function having input parameters that are based on the one or more binary values.

In an example embodiment of the present invention, the providing of the interface includes providing a webpage having a first frame in which the stem description and task description are displayed and a second frame in which objects representative of the instantiated at least one target application are displayed.

According to an implementation of this embodiment, the method further includes transmitting the webpage to a user terminal for performance of the interaction at the user terminal.

In an example embodiment of the present invention, which may be combinable with the previously described embodiment or implemented without the previously described embodiment, the providing of the interface includes displaying an object selectable via a user input device, the selection being interpreted by the one or more processors as an indication that the at least one task is complete, and the execution of the evaluation queries being performed responsive to the selection.

In an example embodiment of the present invention, which may be combinable with one or more of the previously described embodiments or implemented without the previously described embodiments, the execution of the one or more stored evaluation queries is performed in an order specified by one or more defined checkpoints, each checkpoint associable with a plurality of the one or more stored evaluation queries.

According to an implementation of this embodiment, the method further includes: for each checkpoint, determining a respective binary result based on binary results of evaluation queries with which the checkpoint is associated, where the binary results of the checkpoints are used as the input parameters of the scoring expressions.

According to an implementation of this embodiment, which may be combinable with the previously described implementation of this embodiment or implemented without the previously described implementation of this embodiment, a checkpoint specifies, for each of its associated evaluation queries, a virtual server on which the query is to be run.

According to an implementation of this embodiment, which may be combinable with one or more of the previously described implementations of this embodiment or implemented without the previously described implementations of this embodiment, a scoring expression defines an algebraic function whose input parameters are the computed binary results of a plurality of the checkpoints.

According to an implementation of this embodiment, which may be combinable with one or more of the previously described implementations of this embodiment or implemented without the previously described implementations of this embodiment: the test scenario is instantiated upon selection of a file associated with the test scenario, the evaluation queries, the checkpoints, and the scoring expressions; a virtual machine is assigned to each instantiation of the test scenario; and the queries for the instantiated test scenario are loaded into an evaluator assembly and run on the virtual server assigned to the instantiated test scenario.

An example embodiment of the present invention is directed to a hardware computer-readable medium having stored thereon instructions executable by a processor, the instructions which, when executed, cause the processor to perform a testing method, the testing method including: instantiating a test scenario that includes a description of a stem that defines a context and at least one task to be performed in accordance with the context and via interaction with at least one target application; providing an interface to an instance of the at least one target application for the interaction; executing one or more stored evaluation queries to check a status of the instance of the at least one target application and record one or more binary values based on the status; and executing one or more stored scoring expressions to generate and output a score, the scoring expression defining a function having input parameters that are based on the one or more binary values.

An example embodiment of the present invention is directed to a computer system, including one or more processors configured to: instantiate a test scenario that includes a description of a stem that defines a context and at least one task to be performed in accordance with the context and via interaction with at least one target application; provide an interface to an instance of the at least one target application for the interaction; execute one or more stored evaluation queries to check a status of the instance of the at least one target application and record one or more binary values based on the status; and execute one or more stored scoring expressions to generate and output a score, the scoring expression defining a function having input parameters that are based on the one or more binary values.

### BRIEF DESCRIPTION OF THE DRAWINGS

FIG. 1 shows an overview of a system for authoring and delivering performance-based emulation tests, according to an example embodiment of the present invention.

FIG. 2 shows a process of authoring the scenario elements, according to an example embodiment of the present invention.

FIG. 3 illustrates how the system may perform the automated grading on a scenario for a test taker, according to an example embodiment of the present invention.

### DETAILED DESCRIPTION

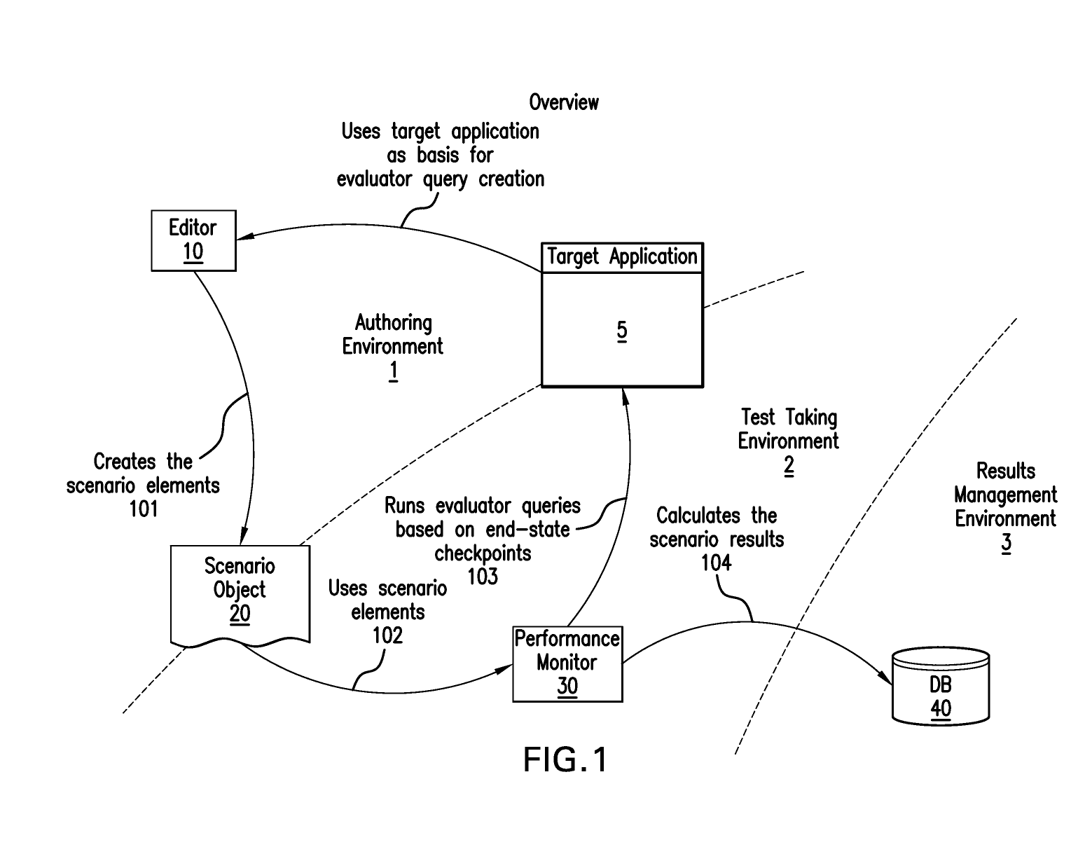

FIG. 1 shows an overview of a system for authoring and delivering performance-based emulation tests, according to an example embodiment of the present invention. In an example embodiment of this invention, an author may, at step 101, use an Editor application 10 in an authoring environment 1 to create a scenario having scenario objects or elements 20, such as scenario stems, evaluator query scripts for a target application 5 being tested, individual checkpoints to be evaluated, and scoring expressions to determine grading.

When a test taker uses defined scenario elements 20, e.g., the scenario stems, to perform tasks defined in the scenario in a test taking environment 2, a performance monitor module 30 may observe the activities of the test taker and may, at step 102, obtain the scenario elements 20 defined by the author to, at step 103, run evaluator queries as specified in the end state checkpoints. For example, the checkpoints may specify which evaluator queries to be run, an order in which they are to be run, and the virtual servers on which they should be run. The evaluator queries provide for checking a status of the target application 5 to determine whether the tasks which the scenario elements 20 specify have been correctly performed. With respect to the order in which they are run, the order may be significant. For example, a task may include create a file, place words in the file, and encrypt the file. Execution of a query which causes a processor to decrypt a file may be required to be run prior to a query which causes the processor to read the result. With respect to the specification of the virtual servers on which the queries are to be run, it may occur, for example, that a task includes accessing a file server, a mail server, and a domain controller. Thus, the checkpoints would therefore specify that the evaluator queries for checking the status of each would run on those respective servers. At step 104, the scoring results may be calculated and stored in a database 40 of a results management system 3.

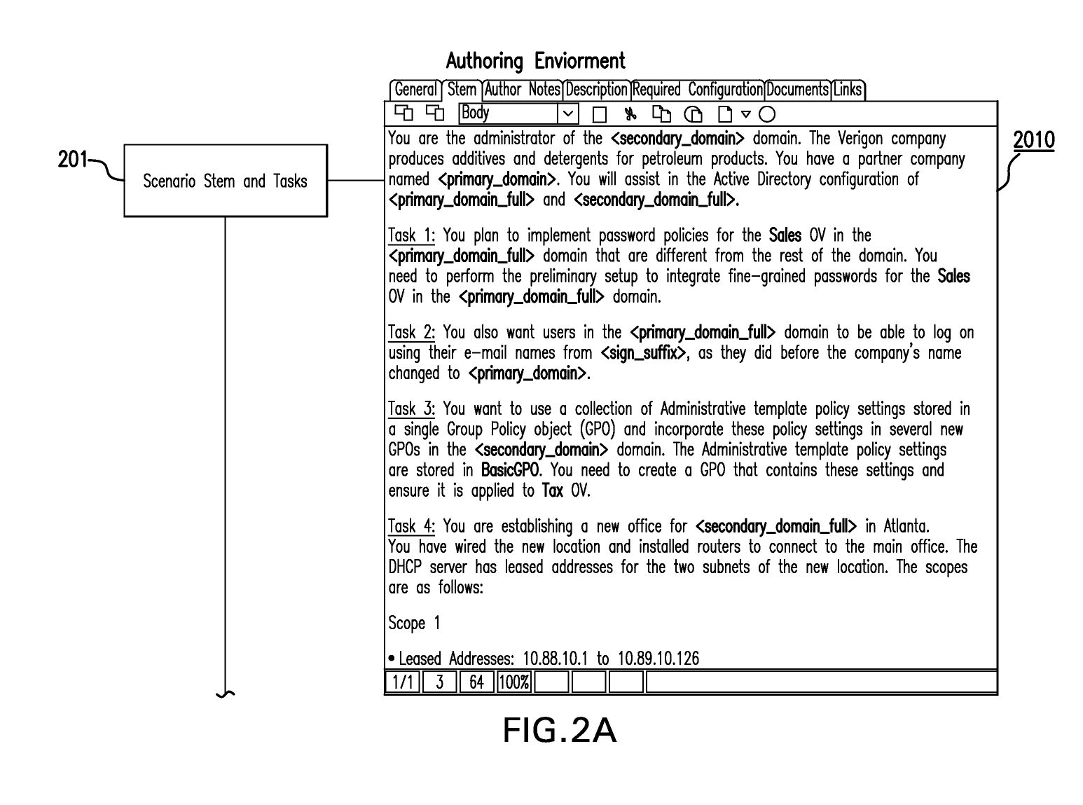

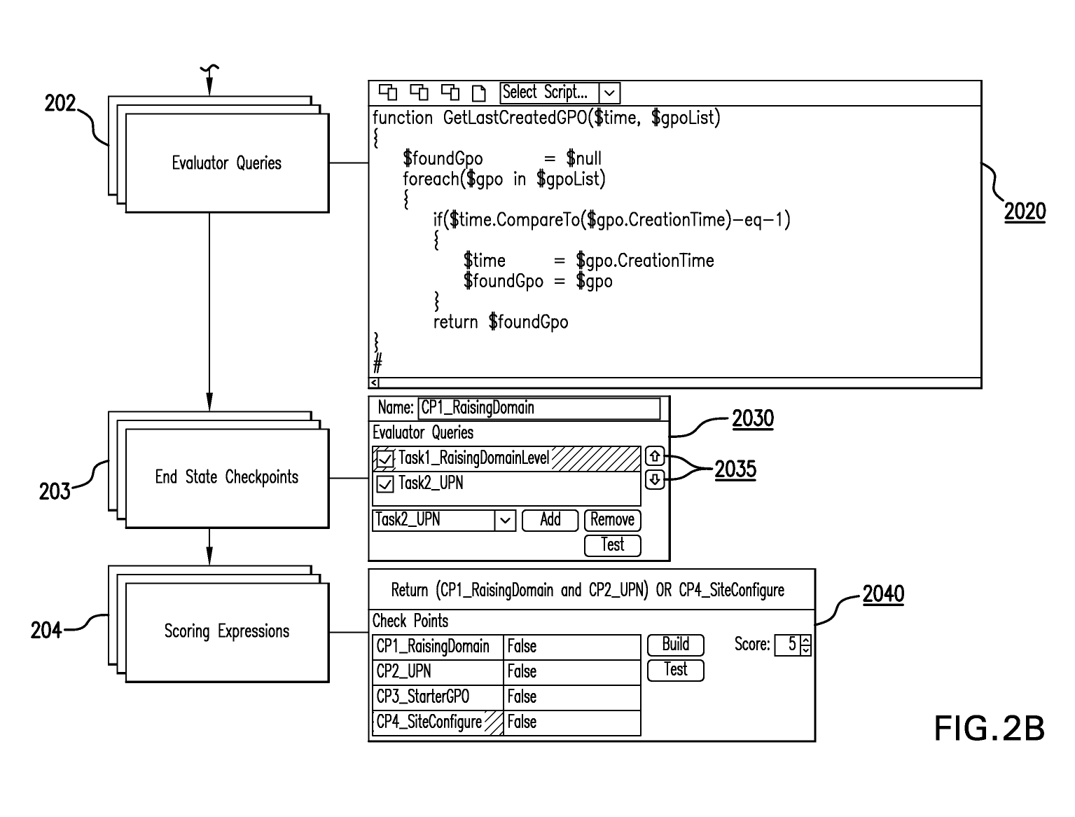

FIG. 2 shows an example process of authoring the scenario elements 20. The process may begin, at step 201, by creating a scenario stem which may include a question and task text, e.g., a description of a scenario context and a list of one or more tasks to be performed in that context, for example as shown in screenshot 2010. In an example embodiment of this invention, this may be done in the Editor application 10 used by the author. The task text may describe the desired outcomes the test taker must achieve which will be inspected by a grader.

At step 202, the evaluator queries may be defined and coded to inspect the task outcomes defined in the scenario stem. As explained below, a checkpoint may be used to associate the evaluator queries with the tasks whose outcomes the evaluator queries are to inspect. In an example embodiment of this invention, the evaluator queries may be scripts written in Powershell, e.g., as shown in screenshot 2020, that inspect the appropriate information store on a server, e.g., a virtual server, to evaluate the task outcome for correctness and return a binary result. For example, a task of a scenario stem may be to set up a DNS conditional forwarder on a WINDOWS 95 Server. Once the test taker indicates that the test taker has completed the task, e.g., when selecting an end button, or when a time limit has been reached, an evaluator query that is run may cause a processor to query an information store to evaluate the end-state of the DNS setup and determine whether the conditional forwarder was set up as specified by the task.

At step 203, an end state checkpoint may be defined, e.g., as shown in screenshot 2030, to link the evaluator query/queries to a specific task. In an example embodiment of the present invention, the checkpoint may be associated with tasks and, by virtue of the grouping of evaluation queries in association with a checkpoint, the queries may be associated with the tasks. For example, in screenshot 2030, the checkpoint is shown to be associated with a task called CP1_RaisingDomain. Further, performance of a task may provide multiple results/aspects, and there may be multiple checkpoints corresponding to the multiple results/aspects of a task. On the flip side, a single checkpoint may be set up which corresponds to multiple results/aspects of a task and/or to multiple tasks. As more fully described below, the division of tasks and/or task aspects by checkpoint may determine how scoring is performed, since a result of checkpoint, rather than a query, may be assigned points. A checkpoint may have one or more evaluator queries attached to it. The checkpoint may define the order in which these queries should be run. The system and method may provide a user interface in the authoring environment that includes a tool for defining the order in the checkpoint. For example, arrows 2035 may be used to move a selected evaluation query up or down in a list of evaluation queries that have been added to the checkpoint. In an example embodiment of this invention, the Editor application 10 may enable the author to choose the evaluator queries and order them as they are attached to the checkpoint. For example, a user interface may be provided in which a new checkpoint is active during definition of the checkpoint, and the user interface may include a selection feature for selecting from previously defined evaluator queries and ordering them.

At step 204, the author may define, e.g., as shown in screenshot 2040, a scoring expression which determines a point value for the correct result of performing the tasks evaluated by one or more checkpoints. In an example embodiment of the present invention, the system and method may provide for the Author to write an algebraic expression using a combination of checkpoints. For example, a scoring expression may provide that [[Checkpoint_{—}1 AND Checkpoint_{—}2] OR Checkpoint_{—}3]=12 points, so that 12 points would be awarded either for correctness of both Checkpoint_{—}1 and Checkpoint_{—}2 or for correctness of Checkpoint_{—}3. The evaluation of the expression to true at runtime may assign a specific point value set by the Author in the scoring expression.

While checkpoints may increase flexibility and manipulation of queries for obtaining a score, in an alternative example embodiment, scoring expressions may refer directly to the evaluation queries, rather than to checkpoints.

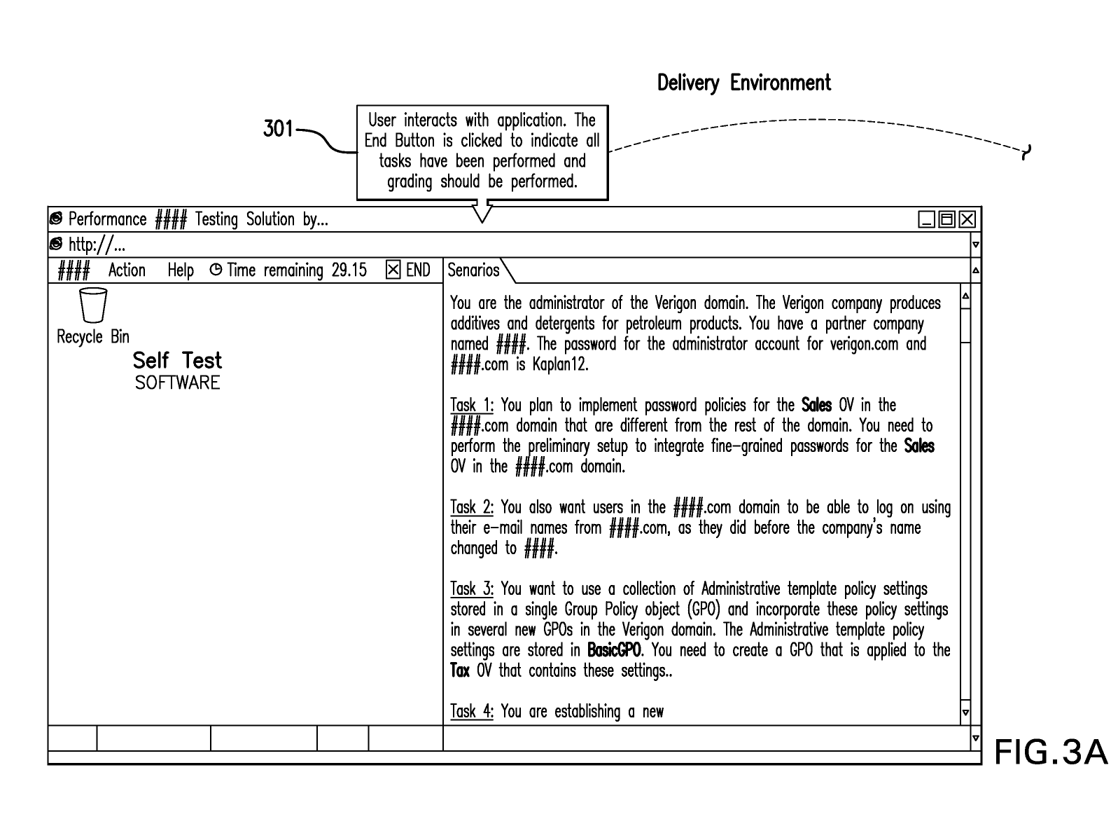

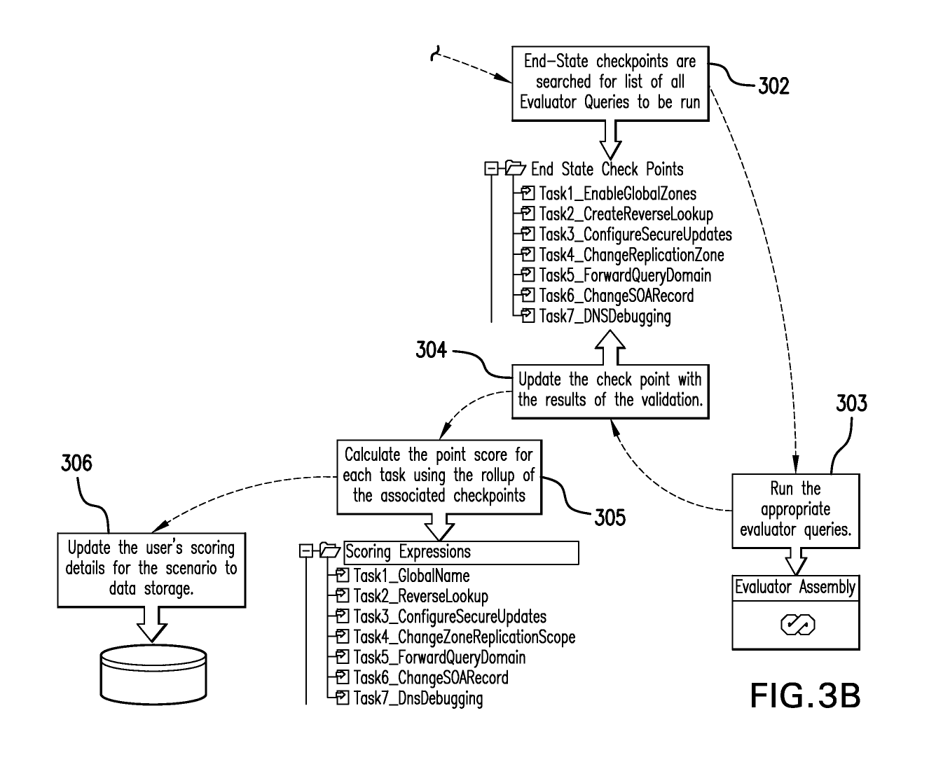

FIG. 3 illustrates how, according to an example embodiment of the present invention, the system may perform the automated grading on a scenario for a test taker once the test taker has indicated that the tasks of the scenario have been completed. The test taker may, at step 301, interact with the target application in a virtual server environment. The test taker may perform the tasks defined by the author in the scenario stem. In an example embodiment of this invention, the scenario stems may be presented in a webpage where an interface to the virtual servers with which the test taker is to interact for performance of the detailed tasks is provided via the webpage alongside the display of the scenario stem. For example, a single window with multiple frames may be provided. When the test taker has completed the test taker's attempts with the tasks described in the scenario stem, clicking an End button on the web page by the test taker may indicate to the system that an automated grading process can proceed.

At step 302, the list of end state checkpoints defined by the Author may be searched and applied at runtime to the virtual machine(s) assigned to the test taker to be scored. For example, a test file may be stored which includes or points to a test scenario and associated scoring expressions, checkpoints, and/or evaluation queries. The system and method may provide for a server to be accessed remotely by a plurality of test takers, each test taker taking the same or different tests supported by the server, each test taker being assigned a respective one or more virtual servers on which to take the test defined by a particular test file.

The queries, ordered as specified by the checkpoints, may, at step 303, be loaded into the appropriate evaluator assembly and run on the virtual servers to return binary results on whether the queries evaluated to respective correct or incorrect state results for the respective tasks.

At step 304, the results of the evaluator queries may be stored in appropriate combination as binary checkpoint results and for the user associated with the results. In a preferred example embodiment of this invention, the binary results of the checkpoints may be updated in a database for subsequent processing by the results management system 3.

At step 305, the results of the ordered list of evaluator queries identified in step 302 may be substituted by checkpoint into the scoring expressions defined by the Author. These scoring expressions may be evaluated to produce results, and associated points values for each task may be stored in the results management system 3 along with the overall grade for the scenario. The overall grade may be a total of all points accumulated from all tasks.

The overall grade and task level grading may be committed to the database 40 in the results management system 3. In a preferred example embodiment of this invention, the results may be retrievable via web service methods enabling the scoring results to be accessible outside of the delivery system.

An example embodiment of the present invention is directed to a processor, which may be implemented using any conventional processing circuit or combination thereof, a non-exhaustive list of which includes a Central Processing Unit (CPU) of a Personal Computer (PC) or other workstation processor, to execute code provided, e.g., on a hardware computer-readable medium including any conventional memory device, to perform any of the example methods described above alone or in combination, or portions thereof. The memory device may include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

An example embodiment of the present invention is directed to a hardware computer readable medium, e.g., including any conventional memory device as described above, having stored thereon instructions, which, when executed, cause a processor, implemented using any conventional processing circuit as described above, to perform any of the example methods described above alone or in combination, or portions thereof.

An example embodiment of the present invention is directed to a method of transmitting instructions executable by a processor, implemented using any conventional processing circuit as described above, the instructions, when executed, causing the processor to perform any of the example methods described above alone or in combination, or portions thereof.

The above description is intended to be illustrative, and not restrictive. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

What is claimed is:

1. A method for facilitating generation of a test, comprising:
providing by a computer processor an authoring environment that facilitates:
drafting a test scenario including a description of a stem that defines a context and at least one task to be performed in accordance with the context and via interaction with at least one target application;
defining a plurality of evaluation queries, which, when executed, cause a processor to:
check a status of the at least one target application; and
for each of the evaluation queries, record a result of a respective status check as a respective binary result; and
defining a plurality of scoring expressions, each expression associated with a respective one or more of the evaluation queries and defining a respective point scheme to be executed based on the recorded binary results of the respective one or more evaluation queries.

2. The method of claim 1, wherein:
the authoring environment includes a plurality of displayed tabs selectable for access to a respective display area, one of the tabs corresponding to an interactive display area in which a stem is definable in response to user input for interaction with the interactive display area; and
a stem defined in the interactive display area is stored for subsequent retrieval of at least a portion of which as test instructions.

3. The method of claim 1, wherein:
the authoring environment includes a plurality of displayed tabs selectable for access to a respective display area, one of the tabs corresponding to an interactive display area in which a stem is definable in response to user input for interaction with the interactive display area; and
a stem defined in the interactive display area is stored for subsequent application to which of one or more of the plurality of evaluation queries.

4. The method of claim 1, further comprising:
storing in a memory device the test scenario, evaluation queries, and scoring expressions.

5. The method of claim 4, wherein the storing of the test scenario, evaluation queries, and scoring expressions is performed:
by the authoring environment in response to respective user input indicating the completion of the respective ones of the test scenario, evaluation queries, and scoring expressions; and
in such a manner that the test scenario, evaluation queries, and scoring expressions are accessible for administering a test and for processing to score the test.

6. The method of claim 4, wherein the authoring environment stores the at least one task and the plurality of evaluation queries as separate files and facilitates defining one or more checkpoints that associate the evaluation queries with one or more respective ones of the at least one task.

7. The method of claim 4, wherein:
the authoring environment facilitates defining one or more checkpoints;
each checkpoint is associable with a plurality of the evaluation queries; and
a binary result for each checkpoint is computed based on the binary results of the evaluation queries that belong to the checkpoint and is referenced by the scoring expressions.

8. The method of claim 7, wherein, for a checkpoint that is associated with more than one evaluation query, the checkpoint specifies an order in which its associated evaluation queries are to be executed.

9. The method of claim 8, wherein the authoring environment includes a user interface displaying an arrow arrangement selectable via an input device for modifying specification of an order of execution of evaluation queries associated with a checkpoint.

10. The method of claim 7, wherein a checkpoint specifies, for each of its associated evaluation queries, a virtual server on which the query is to be run.

11. The method of claim 7, wherein a scoring expression defines an algebraic function whose input parameters are the computed binary results of a plurality of the checkpoints.

12. The method of claim 4, wherein the stored test scenarios are accessible for instantiation by a plurality of terminals and the evaluation queries and scoring expressions are accessible for instantiation to score the instantiated test scenarios.

13. A computer-implemented testing method, comprising:
instantiating, by one or more computer processors, a test scenario that includes a description of a stem that defines a context and at least one task to be performed in accordance with the context and via interaction with at least one target application;
providing, by the one or more processors, an interface to an instance of the at least one target application for the interaction;
executing, by the one or more processors, one or more stored evaluation queries to check a status of the instance of the at least one target application and record one or more binary values based on the status; and
executing, by the one or more processors, one or more stored scoring expressions to generate and output a score, the scoring expression defining a function having input parameters that are based on the one or more binary values.

14. The method of claim 13, wherein the providing of the interface includes providing a webpage having a first frame in which the stem description and task description are displayed and a second frame in which objects representative of the instantiated at least one target application are displayed.

15. The method of claim 14, further comprising transmitting the webpage to a user terminal for performance of the interaction at the user terminal.

16. The method of claim 13, wherein the providing of the interface includes displaying an object selectable via a user input device, the selection being interpreted by the one or more processors as an indication that the at least one task is complete, and the execution of the evaluation queries being performed responsive to the selection.

17. The method of claim 13, wherein the execution of the one or more stored evaluation queries is performed in an order specified by one or more defined checkpoints, each checkpoint associable with a plurality of the one or more stored evaluation queries.

18. The method of claim 17, further comprising:
for each checkpoint, determining a respective binary result based on binary results of evaluation queries with which the checkpoint is associated, wherein the binary results of the checkpoints are used as the input parameters of the scoring expressions.

19. The method of claim 17, wherein a checkpoint specifies, for each of its associated evaluation queries, a virtual server on which the query is to be run.

20. The method of claim 17, wherein a scoring expression defines an algebraic function whose input parameters are the computed binary results of a plurality of the checkpoints.

21. The method of claim 17, wherein:
the test scenario is instantiated upon selection of a file associated with the test scenario, the evaluation queries, the checkpoints, and the scoring expressions;
a virtual machine is assigned to each instantiation of the test scenario; and
the queries for the instantiated test scenario are loaded into an evaluator assembly and run on the virtual server assigned to the instantiated test scenario.

22. A hardware computer-readable medium having stored thereon instructions executable by a processor, the instructions which, when executed, cause the processor to perform a testing method, the testing method comprising:
instantiating a test scenario that includes a description of a stem that defines a context and at least one task to be performed in accordance with the context and via interaction with at least one target application;
providing an interface to an instance of the at least one target application for the interaction;
executing one or more stored evaluation queries to check a status of the instance of the at least one target application and record one or more binary values based on the status; and
executing one or more stored scoring expressions to generate and output a score, the scoring expression defining a function having input parameters that are based on the one or more binary values.

23. A computer system, comprising:
one or more processors configured to:
instantiate a test scenario that includes a description of a stem that defines a context and at least one task to be performed in accordance with the context and via interaction with at least one target application;
provide an interface to an instance of the at least one target application for the interaction;
execute one or more stored evaluation queries to check a status of the instance of the at least one target application and record one or more binary values based on the status; and
execute one or more stored scoring expressions to generate and output a score, the scoring expression defining a function having input parameters that are based on the one or more binary values.
